(19) United States
(12) Patent Application Publication
(10) Pub. No.: US 2019/0297803 A1
(43) Pub. Date: Oct. 3, 2019

(54) HYDROPONICS SYSTEM

(71) Applicant: Mark F. Gomez, Pasco, WA (US)

(72) Inventor: Mark F. Gomez, Pasco, WA (US)

(21) Appl. No.: 15/941,341

(22) Filed: Mar. 30, 2018

(51) Int. Cl. A01G 31/06; A01G 27/00

(52) U.S. Cl. CPC A01G 31/06; A01G 2031/006; A01G 27/005

(57) ABSTRACT

An ebb and flow hydroponics system employs one or more containers for growing plants. Each container has a top and bottom, with a drain in the bottom and an overflow near the top. A return system connects the drains and overflow lines to a reservoir. The nutrient solution is delivered through gravity assist from the containers to the reservoir. A pump is connected to the reservoir and delivers nutrient solution under pressure to the containers. The solution is delivered at or near the top of each container to provide a top-feed ebb and flow system. Each container contains pea gravel, or other similar, nonporous material capable of supporting heavy plants, while providing optimal growing conditions. Fill and drain cycle time is also controlled for optimal growing conditions. Temperature and evaporation is controlled in part by placing the reservoir and a portion of the return system underground.

### COPYRIGHT NOTICE

This disclosure is protected under United States and International Copyright Laws. © 2018 (Mark F. Gomez). All Rights Reserved. A portion of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever.

### CROSS-REFERENCE TO RELATED APPLICATIONS

This application is related to co-pending U.S. application Ser. No. 15/041,364 filed Feb. 11, 2016; and PCT Application No. PCT/US2016/017480 filed Feb. 11, 2016; both of which claim priority to U.S. Provisional Application No. 62/114,981 field Feb. 11, 2015. All of the above-referenced applications are hereby incorporated by reference in their entireties as if fully set forth herein.

### FIELD OF THE INVENTION

The present invention relates generally to agriculture and more particularly to hydroponics systems and more particularly to top-feed ebb and flow hydroponics systems.

### BACKGROUND OF THE INVENTION

Hydroponics, the growing of plants without soil, is well known. Benefits of hydroponics include an absence of soil, less water consumption, easier pest and disease control, lower nutritional requirements, and higher crop yield, just to name a few. Ebb-and-flow hydroponics is a known hydroponics technique in which a nutrient solution floods a growth basin containing a plant, which is then drained. The growth basin may sit atop a reservoir that catches the drained solution. A submerged pump in the reservoir pumps the solution through the bottom of the growth basin and the cycle repeats. Sometimes an overflow pipe may be used to prevent the basin from overfilling and drains the excess solution back to the reservoir. A timer typically controls the cycling of the nutrient solution into the growth basin.

The plant usually sits atop a growth medium, which may be an organic or inorganic material, such as lava rock, perlite, vermiculite or rock wool, to name a few. Typically, the medium is porous, allowing it to retain moisture and nutrients between cycles. However, these characteristics also allow for water born bacteria, algae and other impediments to healthy plant growth to develop. In addition, these types of mediums are often light weight and do not properly support the plants, especially larger, heavier plants such as food crops (peppers and tomatoes) and certainly not landscaping plants, such as bushes and fruit trees.

Outdoor hydroponics systems must contend with changing weather conditions, which may lead to evaporation and temperature variations of the nutrient solution. Seasonal and daily temperature swings require supplemental heating and cooling of the solution or replenishing the system with additional, warmer or cooler solution. Likewise, evaporation requires regular replenishment. For larger-scale systems, as might be found in commercial applications, the temperature regulation and replenishment of the nutrient solution becomes a significant task, both in expense and labor, and may lead to lower plant yield.

In addition, hydroponics systems intended for home and small-scale systems are not scalable. The designs of such systems typically make them impractical to own and operate on a large scale.

Accordingly, there is a need for an ebb-and-flow hydroponics system that is simple to operate and maintain, scalable for large-scale and commercial installations, suitable for a wide range of plants including those that are large and heavy, and offers consistent performance providing high yields.

### SUMMARY OF THE INVENTION

In accordance with a preferred embodiment of the present invention, a hydroponics system comprises at least one container having a first end and a second end, and further having an overflow port coupled to the first end and a drain port coupled to the second end, a growing medium in the container, a return system coupled to the overflow port and the drain port to receive nutrient solution from the container, a pressure system coupled to supply nutrient solution to the first end of the container, a reservoir coupled to the return system for receiving fluid from the return system and coupled to the pressure system, a controller for controlling the pressure system and a power supply for supplying power to the pressure system.

In accordance with an alternative embodiment of the present invention, a hydroponics method for growing plants comprises the steps of filling a container with nutrient solution through a supply port, the container further having a drain port, an overflow port and growing medium, stopping the filling of the container at a predetermined time, draining the nutrient solution in the container through the drain port, returning the nutrient solution from the drain port to a reservoir, pumping the nutrient solution from the reservoir to the container through the supply port and cycling the filling and draining of the container to provide optimum growing conditions within the container.

In accordance with yet a further embodiment of the present invention, an ebb and flow hydroponics system comprises a plurality of growth containers each having a top and bottom, the containers further having a drain in the bottom and an overflow near the top of the container and coupled to a return system, a reservoir coupled to the return system for receiving nutrient solution from the containers, a pump having an input coupled to the reservoir and an output coupled to the containers for supplying nutrient solution from the reservoir to the top of the containers.

### BRIEF DESCRIPTION OF THE DRAWINGS

Preferred and alternative examples of the present invention are described in detail below with reference to the following drawings:

FIG. 1 is a schematic illustration of a hydroponics system in accordance with a preferred embodiment of the present invention;

FIG. 2 is a perspective view depicting features of the system of FIG. 1;

FIG. 3 is a perspective view depicting various features of a growth container and supply, drain and overflow features of the system on FIG. 1;

FIG. 4 illustrates a growth container suitable for use in the system of FIG. 1;

FIG. 5 is a partial, simplified schematic of a large-scale system in accordance with the present invention;

FIG. 6 is a partial elevation view of a large-scale system of the type represented in

FIG. 5;

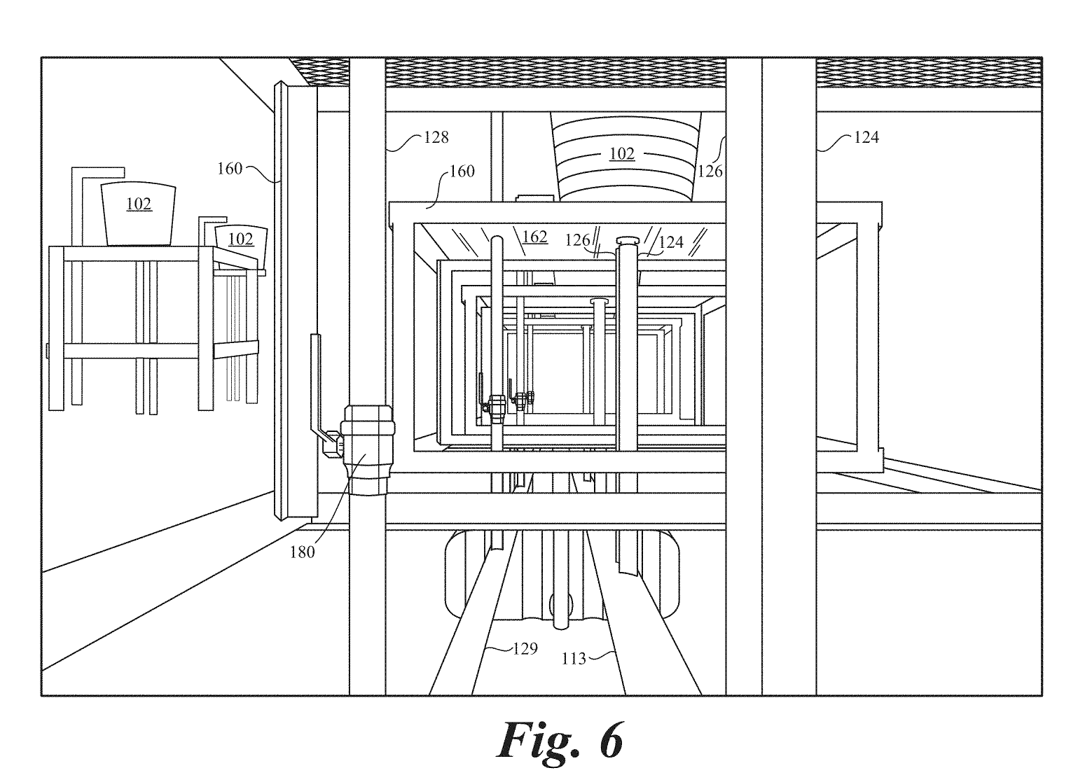

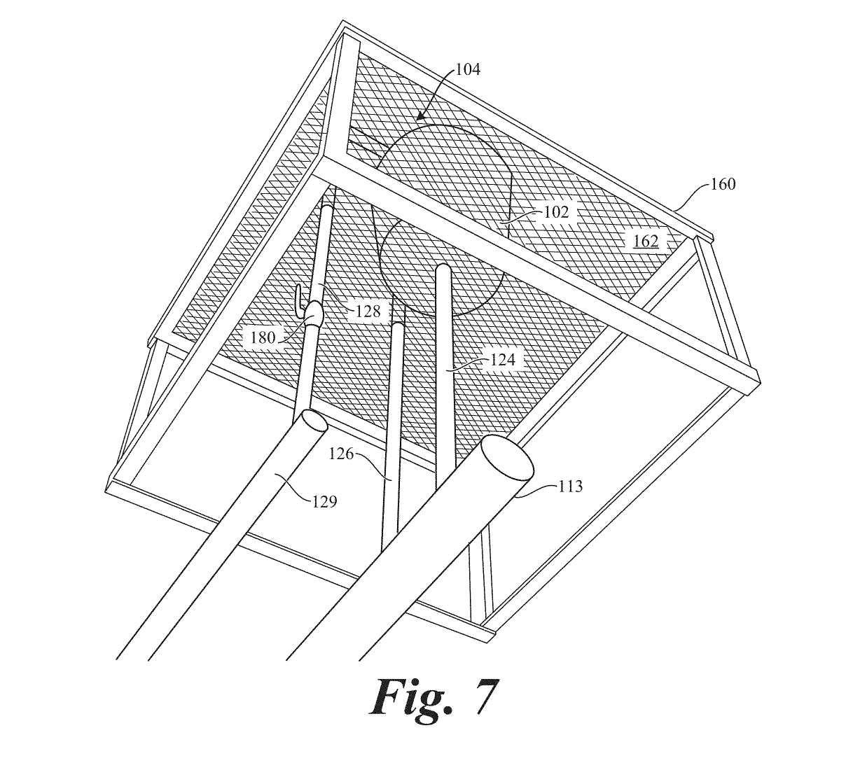

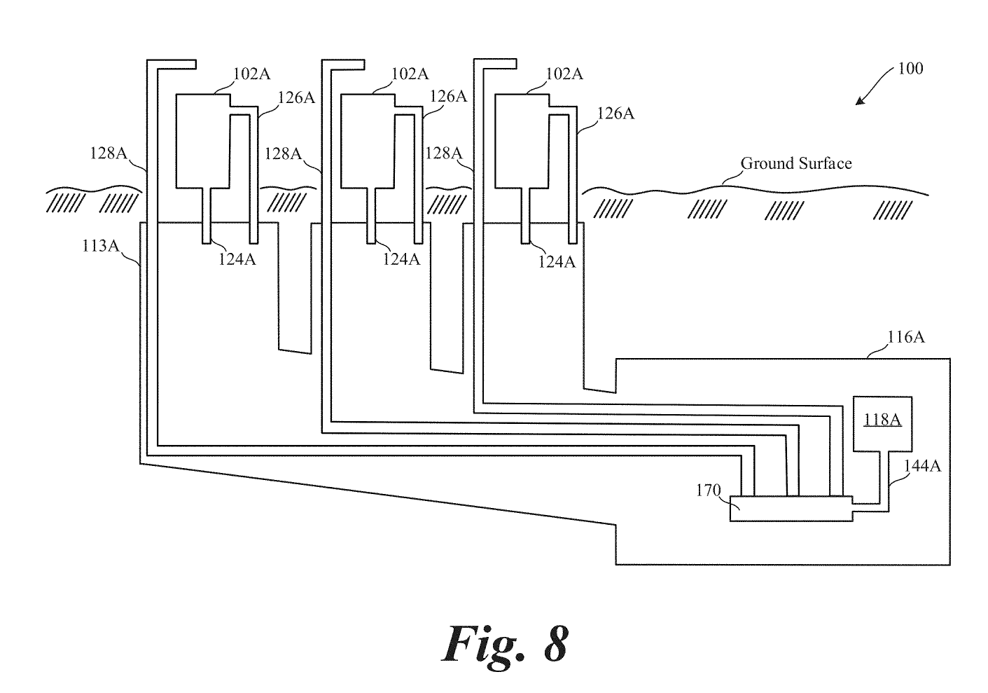

FIG. 7 is a perspective view of a portion of the system of FIG. 6; and,

FIG. 8 is a schematic illustration of a hydroponics system in accordance with an alternative embodiment of the present invention.

### DETAILED DESCRIPTION OF THE PREFERRED EMBODIMENT

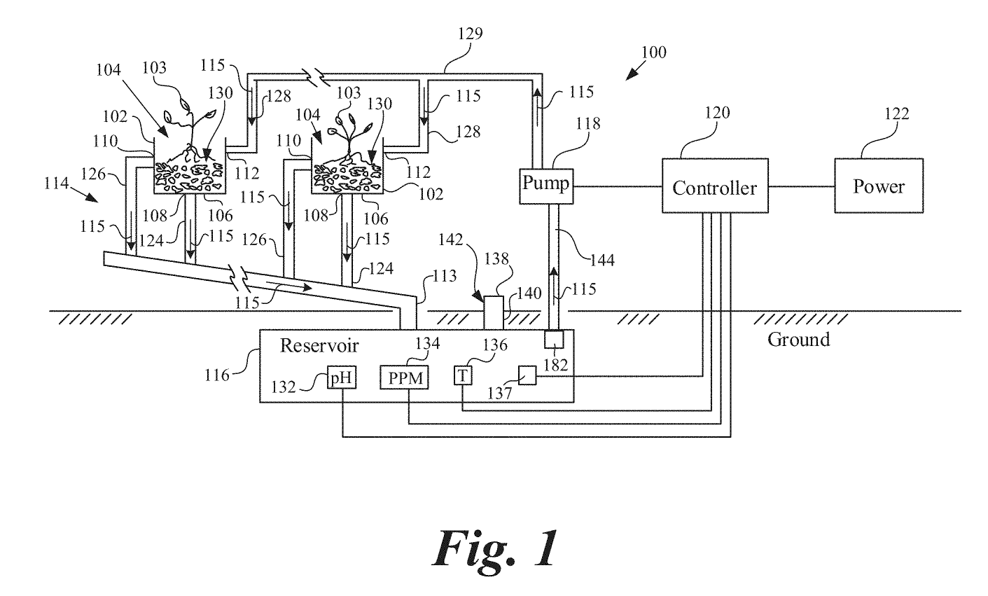

FIG. 1 illustrates schematically an ebb & flow hydroponics system 100 in accordance with a preferred embodiment of the present invention. As illustrated in FIG. 1, system 100 is installed outside, however, it is understood that the system 100 may also be located inside a building or partially inside a building or series of buildings. One or more grow container(s) 102 for growing a plant(s) 103 is located above ground and preferably has an open top 104 and a closed bottom 106. A drain port 108 is located in the bottom 106 and an overflow port 110 located in the side of the container 102 near the top 104. A supply, or fill, port 112 is also located in the side of the container 102 near the top 104. Pipes, conduits, troughs (collectively referred to herein as “lines”) connect the various ports 108, 110, 112 to other elements of the system, which are described below.

Drain line 124 is coupled from the drain port 108 to a return delivery line 113. Similarly, overflow line 126 is coupled from the overflow port 110 to the return delivery line 113. The overflow port 110, overflow line 126, drain port 108, drain line 124 and return deliver line 113 collectively form a return system 114 for delivering a nutrient solution from the container(s) 102 to a reservoir 116. For the sake of simplicity and ease of understanding, nutrient solution is depicted throughout the system 100 by directional arrow 115 and represents the direction of flow of the nutrient solution 115. As illustrated in FIG. 1, the return delivery line 113 is located below the containers 102, and the nutrient solution 115 returns by gravity from the containers 102 via drain line 124 and overflow line 126 to the return delivery line 113.

The nutrient solution is pumped from the reservoir 116 by a pump 118, preferably located above ground, to the containers 102 through a supply main line 129 to individual supply line(s) 128 and supply port(s) 112. Accordingly, the solution is supplied to the containers 102 under pressure by the pump 118. Locating the pump 118 above ground allows for easy access by system operators and maintenance staff. Pump 118 may comprise a single pump or several pumps coordinated to support the needs of the system 100. The pump(s) 118, as well as other operations of system 100 are controlled by controller 120. Power for operation of the system 100, including pump 118, is provided by power supply 122.

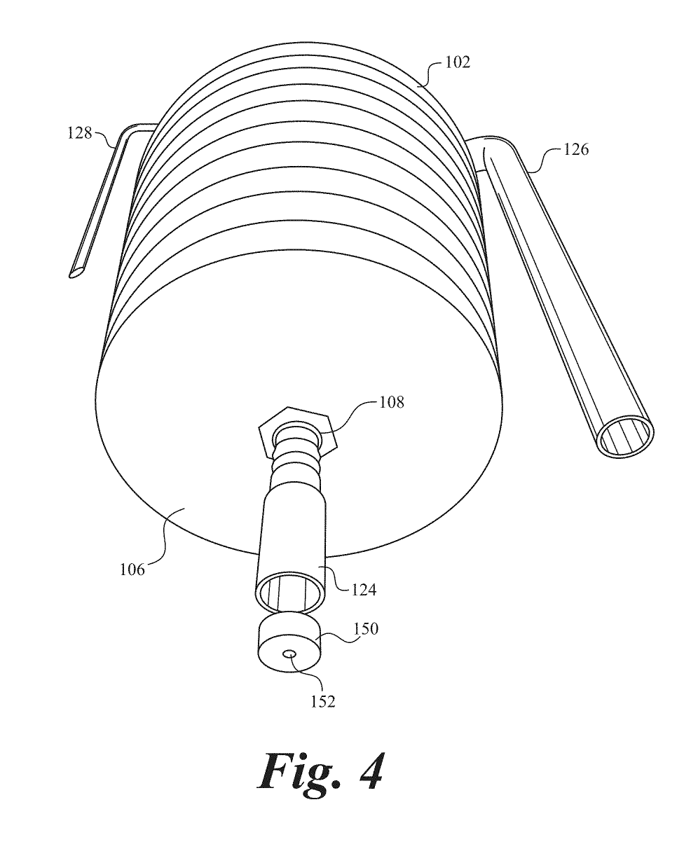

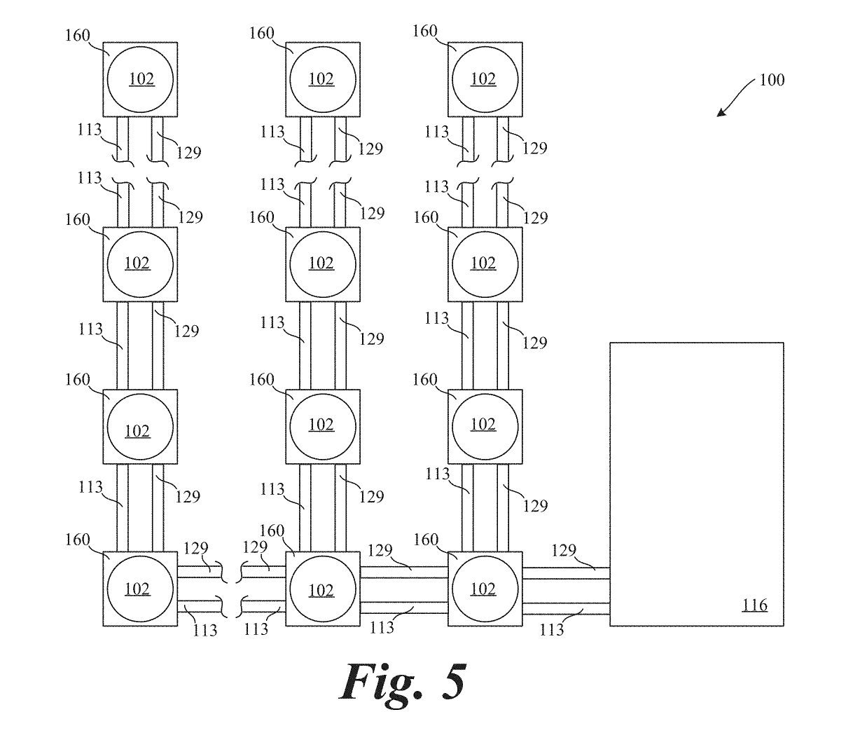

As described above, a supply and recovery cycle of the nutrient solution between the containers 102 and reservoir 116 includes a pressurized supply, or fill, phase and a passive, gravity assist return, or recovery, phase. The supply and recovery cycle time is determined by various parameters of the system, such as, for example, the number of containers 102, capacity of the containers 102, length and diameter of the various supply, and drain lines, and pump capacity. In accordance with an embodiment, a restrictor 150 (FIG. 4) is located in the drain port 108 or drain line 124 for controlling the rate at which the nutrient solution drains from the container 102. For reasons of system simplicity, ease of operation and maintenance, the restrictor 150 is preferably a passive device. Alternatively, the restrictor 150 may be an active device that is remotely controllable, such as an automatic valve, for example. However, such a valve introduces complexity into the system 100, which may or may not be desirable depending on the particular application.

The condition of the nutrient solution is monitored and controlled to provide optimal plant growth and yield. Solution parameters, such as pH, nutrient concentration and temperature are monitored, and possibly controlled, by the controller 120. Accordingly, controller 120 is coupled to sensors monitoring solution pH 132, nutrient concentration (PPM) 134 and temperature 136. A heater 137 is controlled by controller 120 based on input from temperature sensor 136. Sensors 132, 134, 136 and heater 137 are preferable located in reservoir 116. As mentioned above, adjustments to the nutrient solution's pH, concentration (PPM) and temperature may be made through automation, manually or a combination of both.

The gravity return system 114 is enabled in part because of the relative position of the return system 114, the reservoir 116 and the containers 102. In accordance with the preferred embodiment, the reservoir 116 is located underground and the return deliver line 113 is sloped downward from the containers 102 to the reservoir 116. In accordance with the preferred embodiment, the return delivery line 113 is located partially above ground, in the proximity to the containers 102, and below ground in the proximity to the reservoir 116. Alternatively, the reservoir 116 could be located above ground, but still below the containers 102 to allow for gravity assist return. However, locating the reservoir 116 underground, and preferably a portion of the recovery system 114, allows for better temperature control of the nutrient solution.

The underground reservoir 116 is preferably accessible through an access tube 140, which may, for example, consist of a vertical pipe or conduit that extends from the reservoir 116 to a point above ground. Above-ground portion 142 may include a hatch 138 or series of openings that allow, for example, the introduction of water and nutrients (nutrient solution 115) into the reservoir 116. The additional solution may be needed, for example, because of evaporation over extended time or because of changes to the system 100, such as the addition of containers 102 or the growth of plants 103. For large commercial systems 100, the above ground portion 142 may also allow access into the reservoir 116 by a system operator or maintenance personnel.

As depicted in FIG. 1, the container(s) 102 include a growing medium 130 suitable for supporting small as well as large plants, while providing proper drainage and optimal system performance. For example, system 100 is suitable for growing plants such as avocados, all citrus plants, peppers, eggplant, kiwi, mango and papaya. In accordance with the preferred embodiment, pea gravel is used as the growing medium 130. Unlike other types of growing mediums, the relatively unrestricted flow of the nutrient solution 115 through the pea gravel 130 (limited primarily by the orifice 152 of restrictor 150) and the nearly complete emptying of the containers 102 of solution 115 allows for the control of bacteria, algae and other undesirable contaminants in system 100. The pea gravel 130 coupled with the top feed, ebb and flow design of system 100 also allows for optimal oxygen exchange with the root systems of the plants 130 in containers 102.

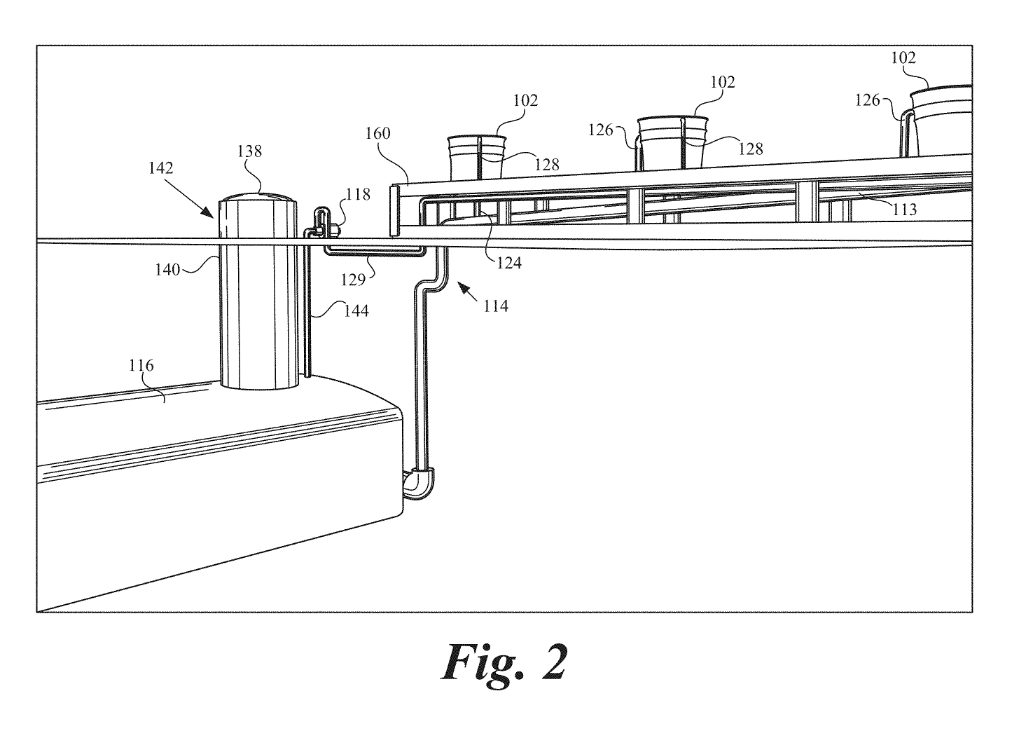

FIG. 2 is a perspective view of an embodiment of the system 100 of the present invention. Structure 160 supports a plurality of containers 102, and the above-ground portions of the return delivery line(s) 113 and supply main line(s) 129. The structure may also support the individual supply lines 128, drain lines 124 and overflow lines 126 coming from the containers 102. As previously discussed, the above ground portion of the return delivery line 113 has a downward slope from the containers 102 toward reservoir 116. Beginning at a low point of the above ground portion of the return delivery line 113, it proceeds underground to the reservoir 116. An input of the pump 118 is also connected to the reservoir 116 by a feed line 144. From the above ground pump 118, the feed line 144 travels underground to the reservoir 116. An output of pump 118 is coupled to the supply main line(s) 129 of the system 100 and provides the nutrient solution under pressure to the container(s) 102. Accordingly, the pump 118 supplies nutrient solution under pressure to the containers 102 during the pressurized supply phase, and the drain lines 124 and overflows lines 126, and hence the return system 114, return the solution from the containers 102 to the reservoir during the gravity assist return phase, thus completing a fill and drain cycle.

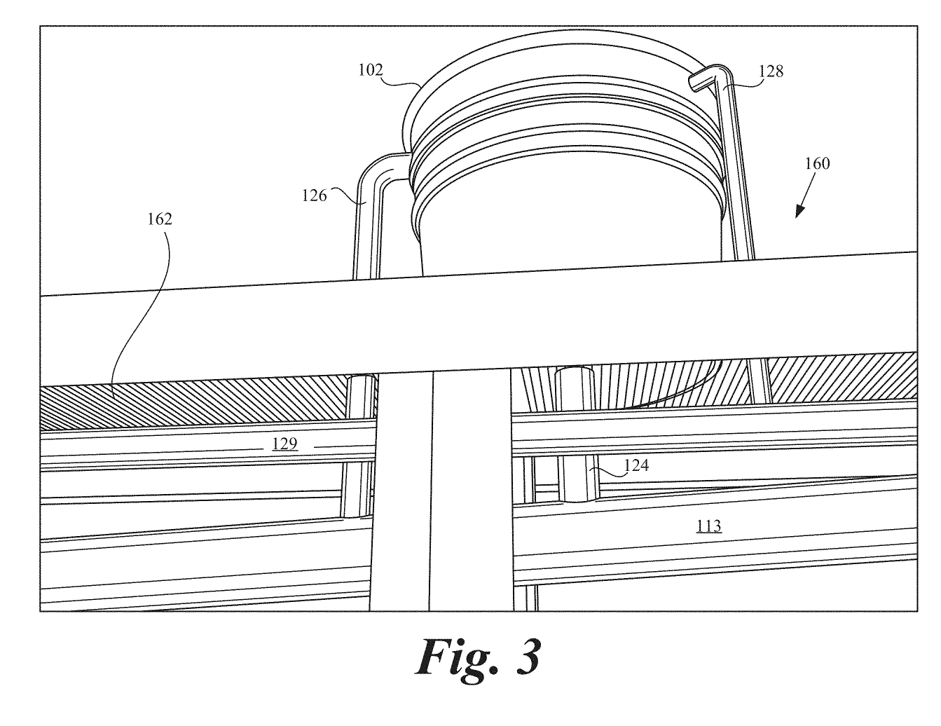

FIG. 3 further illustrates relationships between the support structure 160, a container 102, drain line 124, overflow line 126 and supply line 128. As illustrated in FIG. 3, container 102 preferably sits on platform 162 of structure 160, with lines 124, 126 and 128 passing from container 102 to the respective return delivery line 113 and supply main line 129. The downward slope of return delivery line 113 toward the reservoir 116 (not shown) is apparent in FIG. 3.

FIG. 4 is a partially exploded view of a portion of system 100 showing the restrictor 150 and drain line 124. In actual operation, restrictor 150 is located in the drain line 124 of a container 102. The restrictor 150 includes an orifice 152 comprising an opening whose size is a function of the demands of system 100. The flow rate of the nutrient solution 115 (FIG. 1) draining from container 102 is controlled, at least in part, by the orifice 152 of restrictor 150. A passive restrictor 150, as shown in FIG. 4, is preferable for system simplicity and ease of maintenance. This may be particularly important in large scale applications of the system 100, which may include hundreds or thousands of containers 102. In such a large installation, reducing operational complexity and maintenance requirements becomes critical to the overall performance and financial viability of system 100.

In accordance with an alternative embodiment, restrictor 150 may be an active device, such as a locally or remotely controlled valve that provides variable openings (152) and flow rates in the container drain line 124. Control of these active restrictors 150 may include sensors in the containers 102 that monitor characteristics, such as moisture or solution level in container 102, by way of example. Control of active restrictors 150 may be manual or controlled automatically or semi-automatically by controller 120 depending upon the requirements of system 100.

The system may also include a filter or filtration system 182, for removing contaminants from the nutrient solution. Such contaminants may, for example, include plant material or other debris. Preferably, the filter is located in a position allowing for easy access for routine maintenance. For example, the filter 182 may be located in reservoir 116 to filter out contaminants prior to entering the pump 118. As previously discussed, the system 100 is simple, easy to operate and maintain for small, personal installations and is also scalable for large, commercial installations. FIG. 5 illustrates, by way of a nonlimiting example, a large scale system 100 in accordance with an embodiment of the present invention. As depicted in FIG. 5, system 100 includes several containers 102, numbering in the hundreds or even thousands. There is no limit to the number of containers 102 used in system 100. Multiple support structures 160 support containers 102. In the present example, FIG. 5 illustrates one support structure 160 for each container 102, but it is understood that this ratio is merely an example and that a structure 160 may also support more than one container 102. Multiple, discrete support structures 160 may be desirable in certain situations. For example, for large containers 102 or very large plants 103, such as trees, the spacing of containers 102 may make it desirable to have separate structures 160 for each container 102. Line 113, 129 may be supported by structures 160, other structures (not shown) on the ground or even underground. Reservoir 116 may consist of a single nutrient reservoir or multiple reservoirs depending on the needs of the system 100. Likewise, multiple reservoirs 116 may be centrally located or distributed throughout the system 100.

FIG. 6 is a partial elevation view of a large-scale system 100 (as was briefly described above) in accordance with an embodiment of the present invention. Individual structures 160 and platforms 162 support containers 102. Fill 128, drain 124 and overflow 126 lines pass through platforms 162 and connect to return delivery 113 and supply main 129 lines. Return delivery lines 113 and supply main lines 129 are connected to reservoir 116 as previously described. As depicted in FIG. 6, the return delivery lines 113, supply main lines 129 and reservoir 116 are underground and structures 160 sit on or above ground. Further in accordance with the present invention, each fill line 128 shown in FIG. 6 is terminated above the top 104 of container 102. This allows the nutrient solution 115 to flow from line 128 into the top opening of container 102. This configuration is functionally the equivalent to running the fill line 128 through the side of the wall of the container 102 near the top 104 (see FIGS. 1-3). Both configurations provide a top-fill ebb and flow system 100.

In accordance with a preferred embodiment, a cut-off, or flow control, valve 180 is located in the fill line 128 (FIGS. 1 and 8). This allows for control of the nutrient flow 115 into each container 102. Valve 180 also allows the fill line 128 to be closed so that an individual container 102 may be maintained or replaced as needed without disturbing the rest of system 100.

FIG. 7 illustrates in somewhat greater detail the drain line 124 and overflow line 126 exiting container 102 and entering the return line 113 and fill line 128 terminating above the opening 104 of container 102 and coupled the the supply main line 129 through cutoff/flow control valve 180.

FIG. 8 illustrates an alternative embodiment of the present invention in which fill lines 128A are located within the drain lines 124A. The fill lines 128A may also be placed inside the overflow lines 126A. Such an arrangement may provide for a cleaner appearance and possibly offer protection to the individual lines by grouping them together. In this embodiment, the pump 118A and a manifold 170 may be submerged in the reservoir 116A to control flow of the solution 115 (not shown in FIG. 8) in the fill lines 128a used to control flow.

While the preferred embodiment of the invention has been illustrated and described, as noted above, many changes can be made without departing from the spirit and scope of the invention. For example, the restrictor 152 may be located in the drain port of each container 102 (as opposed to the drain line 124), the fill line 128 may enter the top opening 104 of the container 102, rather than entering through the side of the container 102 near the top 104, support structure 150 may include a plurality of structures depending on the layout of the system, and similarly, the return system 114 may include a plurality of return delivery lines 113. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A hydroponics system comprising:
a container having a first end and a second end, and further having an overflow port coupled to the first end and a drain port coupled to the second end;
a growing medium in the container;
a return system coupled to the overflow port and the drain port to receive nutrient solution from the container;
a pressure system coupled to supply nutrient solution to the container;
a reservoir coupled to the return system for receiving fluid from the return system and coupled to the pressure system;
a controller for controlling the pressure system; and,
a power supply for supplying power to the pressure system.

2. The system of claim 1 wherein the pressure system comprises a pump for receiving fluid from the reservoir and providing the nutrient solution under pressure to the container.

3. The system of claim 2 wherein the pressurized system further comprises supply lines coupled to the pump and to the first end of the container.

4. The system of claim 3 wherein the first end is near an uppermost point of the container and the second end is near a lowermost point of the container.

5. The system of claim 4 wherein the return system and reservoir are positioned below the containers allowing for gravity return of the nutrient solution from the overflow and drain ports of the container.

6. The system of claim 5 wherein the return system is underground.

7. The system of claim 1 wherein the flow rate of nutrient solution through the drain is less than the flow rate through the supply line.

8. The system of claim 7 wherein the controller comprises at least one from the group of a pH module, PPM module, timer module and heater module.

9. The system of claim 8 wherein the supply lines are at least partially contained within the return system.

10. The system of claim 9 wherein the growing medium is pea gravel.

11. A hydroponics method for growing plants comprising the steps of:
filling a container with nutrient solution through a supply port, the container further having a drain port, an overflow port and growing medium;
stopping the filling of the container at a predetermined time;
draining the nutrient solution in the container through the drain port;
returning the nutrient solution from the drain port to a reservoir;
pumping the nutrient solution from the reservoir to the container through the supply port; and,
cycling the filling and draining of the container to provide optimum growing conditions within the growing medium.

12. The method of claim 11, further comprising the step of returning nutrient solution overflow from the container through the overflow port to the reservoir.

13. The method of claim 12, further comprising the step of returning the nutrient solution to the reservoir through gravity assist.

14. The method of claim 13, further comprising the step of supplying the nutrient solution to the container under pressure.

15. The method of claim 14 further comprising the step of controlling the level of the nutrient solution in the container with the overflow port.

16. The method of claim 15 further comprising at least one of the steps of:
controlling the relative pH of the nutrient solution;
controlling the concentration levels of the nutrient solution; and,
controlling the temperature of the nutrient solution.

17. An ebb and flow hydroponics system comprising:
a plurality of growth containers having a top and bottom, the containers further having a drain in the bottom and an overflow near the top of the container and coupled to a return system;
a reservoir coupled to the return system for receiving nutrient solution from the containers;
a pump having an input coupled to the reservoir and an output coupled to the containers for supplying nutrient solution from the reservoir to the containers.

18. The system of claim 17 further comprising a control system for controlling at least one system variable from the group of nutrient solution flow rate, pH, PPM and temperature and system cycle time.

19. The system of claim 18 further comprising a power supply coupled to operate the pump and control system.

20. The system of claim 19 further comprising a restrictor coupled to the drain line and operative to control the flow rate in the drain line and the cycle time for draining and filling the containers.
